(19) United States
(12) Patent Application Publication
(10) Pub. No.: US 2017/0025914 A1
(43) Pub. Date: Jan. 26, 2017

(54) A CONDUCTOR BAR FOR AN ELECTRIC MACHINE

(71) Applicant: ALSTOM TECHNOLOGY LTD., Baden (CH)

(72) Inventors: Thomas BAUMANN, Birr (CH); Thomas HILLMER, Birr (CH)

(21) Appl. No.: 15/301,730

(22) PCT Filed: Mar. 31, 2015
(86) PCT No.: PCT/EP2015/056994

§ 371 Date: Oct. 4, 2016

(30) Foreign Application Priority Data
Apr. 8, 2014 (EP) 14163868.4

(51) Int. Cl. H02K 3/30; H01B 3/30; H02K 3/12; H01B 3/08; H02K 15/12; H01B 3/04; H01B 3/42

(52) U.S. Cl. CPC H02K 3/30; H01B 3/04; H01B 3/305; H01B 3/423; H01B 3/08; H02K 15/12; H02K 3/12

(57) ABSTRACT

The present disclosure relates to an insulated conductor bar, a use of a certain material for manufacturing an insulated conductor bar, and to a method for impregnating an insulated conductor bar. An object of the invention is to provide an alternative impregnation of a conductor bar for an electric machine. The invention discloses an insulated conductor bar for an electric machine having an insulation from a tape made from mica material, mica material on a glass fabric, or mica material on a polyester film, whereas a thermoplastic material is applied to the mica material or the mica material on a glass fabric.

### TECHNICAL FIELD

The present disclosure relates to an insulated conductor bar, a conductor bar insulation, a use of a thermoplastic material for manufacturing an insulated conductor bar, and to a method for impregnating a conductor bar.

### BACKGROUND

The insulated conductor bars described are especially used in an electric machine, in particular a rotating electric machine such as a synchronous generator to be connected to a gas or steam turbine (turbogenerator) or a synchronous generator to be connected to a hydro turbine (hydro generator) or an asynchronous generator or a synchronous or asynchronous electric motor, or also other types of rotating electric machines.

The insulated conductor bars are used for the stator and are accommodated in axial slots in the stator body. The insulated conductor bars mostly have a drilled arrangement of the strands then referred to as Roebel bars. They are insulated for high voltages when used in the technical field of generators. This free volume is filled with a thermosetting resin, usually epoxy and/or unsaturated polyester. There exist various different methods how to accomplish this, see for instance: C. Stone “Electric Insulation for Rotating machines”, John Wiley, Interscience, chapter 4.

An object of the invention is to provide for an alternative impregnation of an insulated conductor bar and a conductor bar insulation for an electric machine.

### BRIEF DESCRIPTION

An aspect of the invention is an insulated conductor bar and a conductor bar insulation for an electric machine provided with a thermoplastic material.

Another aspect of the disclosure provides the use of a thermoplastic material for manufacturing the conductor bar insulation of an electric machine.

A further aspect of the present disclosure is to provide a method for impregnating a conductor bar insulation with a thermoplastic material.

These and further aspects are attained by providing an insulated conductor bar, a conductor bar insulation, a use of a thermoplastic material for manufacturing a conductor bar insulation, and a method for impregnating a conductor bar insulation in accordance with the accompanying claims.

In an embodiment, thermoplastic materials in the conductor bar insulation do not need to be cured which usually needs hours of dwell time inside the moulding tool in the state of the art. In contrast, the process time is typically well below 1 hour when thermoplastic materials are used.

In an embodiment, the thermoplastic material is not hazardous to the manufacturing personnel and environment. Thermoplastic materials develop no noxious volatile organic compounds, nor they need special precautions for storage since they are solid and chemically stable at room temperature.

In an embodiment, the thermal conductivity of many thermoplastic materials are in the range of 0.25-0.3 W/mK. On the other side, for epoxy as an example of a thermo setting material the thermal conductivity is 0.18 W/mK only. This helps to increase the thermal conductivity of the entire insulation by about 30%.

### BRIEF DESCRIPTION OF THE DRAWINGS

Further characteristics and advantages will be more apparent from the description of a non-exclusive embodiment of the conductor bar and the method to manufacture, illustrated by way of non-limiting example in the accompanying drawings, in which:

FIG. 1 is a schematic side view of a moulding tool consisting of two parts and a conductor bar between these two parts in a first manufacturing step;

FIG. 2 is a schematic side view of a moulding tool according to FIG. 1 in a second manufacturing step with the two parts pressed against each other, a vacuum pump, and a supply feeder for molten thermoplastic material;

FIG. 3 is a schematic side view of a moulding tool according to FIG. 2 in a third manufacturing step;

FIG. 4 is a schematic side view of a moulding tool according to FIG. 3 in a fourth manufacturing step with the two parts removed from each other and the finished conductor bar to be removed from the moulding tool.

### DETAILED DESCRIPTION OF EXEMPLARY EMBODIMENTS

With reference to the figures, these show schematic side views of a moulding tool 15 for manufacturing an insulated conductor bar 3, wherein like reference numerals designate identical or corresponding parts throughout the several views. The insulated conductor bar 3 is defined as the conductor bar 3 enclosed by the insulation 4.

The insulation 4 is composed of layers of mica paper attached to a carrier of glass fabric or polyester film in order to provide mechanical pulling strength needed for the winding process, see below. The bonding of mica paper and carrier is accomplished e.g. by means of dispersing resin powder finely onto the mica paper which is in the form of an ‘endless’ wide tape of about 1 m width. Then both layers are pressed together by means of hot rolls, called calendering. For the further use the wide tape is slit in small tapes typically 20-25 mm wide and 50-200 mm long. These tapes of mica paperglass fabric or mica paper-polyester films are wound spirally around the conductor bars in multiple layers until the required amount of insulation is reached.

FIG. 1 shows a schematic side view of the moulding tool 15 consisting of two parts, a first part 10 above and a second part 20 below. The moulding tool 15 is an automated tool used in a fabrication process of insulating conductor bars 3 comprising heavy metal parts to apply high pressures between the first part 10 and the second part 20. The moulding tool 15 is suitable for a heat-vacuum-pressure process. The core of the conductor bar 3 is commonly made from highly conducting material, commonly copper. The first part 10 of the moulding tool 15 being rectangular with a large prominent part below to essentially fit into a recess of the second part 20. In operation the prominent part of the first part 10 abuts the conductor bar 3 from above while the recess in the second part 20 abuts the conductor bar 3 from below. With other words the conductor bar 3 is located between these two parts 10, 20 of the moulding tool 15 and essentially fills out the gap between these two parts 10, 20 in operation. Around the conductor bar 3 in the moulding tool 15 tapes are wound consisting of glass-mica-paper in this example. A glass mica-paper is a mica-paper which has a support of a glass fiber fabric. An additional layer of thermoplastic tape can be applied as an optional solution. The thermoplastic tape may also be designed as a foil from a thermoplastic material.

### First Embodiment of the Invention

Here, the mica-glass tape is combined with a thermoplastic layer or tape. There are various ways to combine thermoplastic layers or tapes with the mica or mica-glass tapes, for sake of simplicity both denoted as mica tapes in the following. It is to be understood that the term mica used within this disclosure also contains mica tape, mica-glass, mica-glass tapes, mica-paper, glass mica-paper, mica-polyester film and similar mica materials. First, it is disclosed here to wind alternating layers of mica and polymeric tapes at the conductor bar 3. These can either consist of a neat polymeric film or made from a carrier tape made from thermoplastic material. Or, the thermoplastic material is applied onto the mica tape by passing the tape through a bath of the molten or chemically solved thermoplastic material.

An alternative method to apply the thermoplastic material onto the mica is by powder dispersion and subsequent powder fusing. This method offers the possibility to combine the processes of fusing mica paper with the carrier-fabric or carrier-film with the process providing thermoplastic resin needed to fill the free volume in the dry insulation. To this purpose, the thermoplastic powder is dispersed onto the mica paper and then fused together with the carrier by means of calendering.

A further method is direct calendaring of the liquid thermoset onto a mica-carrier tape or between a mica paper and a carrier or between two mica carrier-tapes, or between a mica tape and a mica paper. In this method the thermoplastic material is provided directly into the calender without the need of powder spraying process. Direct calendering offers the possibility to apply the thermoplastic material not only onto the surface of the mica tape, but to impregnate it thoroughly. This can also be used in addition to any of the above described methods. Examples of thermoplastic materials are polyamides of various types (PA), polyesters, especially Polybutylene-terephthalate (PBT), Polyethylene-terephthalate (PET) or Polyethylene naphthalate (PEN), polyoxymethylene (POM), polyetheretherketone (PEEK). Prepared in such a way the conductor bar 3 is aligned between the first part 10 and the second part 20 as shown in FIG. 1 in a first manufacturing step.

### Second Embodiment of the Invention

Here, mica tapes free of thermoplastic materials are used in the first step. The thermoplastic material is fed into the moulding tool 15 by the feeder 30 serving also as a reservoir for the thermoplastic material. This may contain the same thermoplastic materials as used in the first embodiment. However, in order to reach a low viscosity required to guarantee good flow and penetration of the mica tapes, the temperature has to be high, in some cases well above 300° C. In a version of the second embodiment this problem is solved by using low-viscosity precursor materials or oligomeric thermoplastic materials instead of fully polymerized thermoplastics. These materials will react to the final thermoplastic polymer inside the moulding tool 15 in the next steps. Examples for precursor materials are lactames to form Polyamides and for the oligomers cyclic butadiene terephtalate to form PBT. Furthermore, according to the requirements of the application, softeners, tougheners, and antioxidants can be added to the thermoplastic. Shown in the Figs in a schematic way is the insulation 4 around the conductor bar 3 fabricated in a way wholly disclosed in this document.

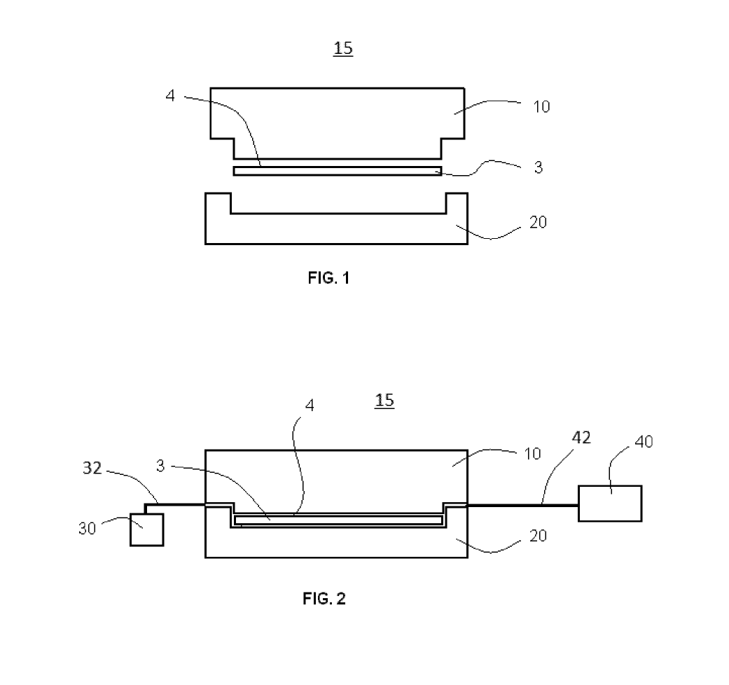

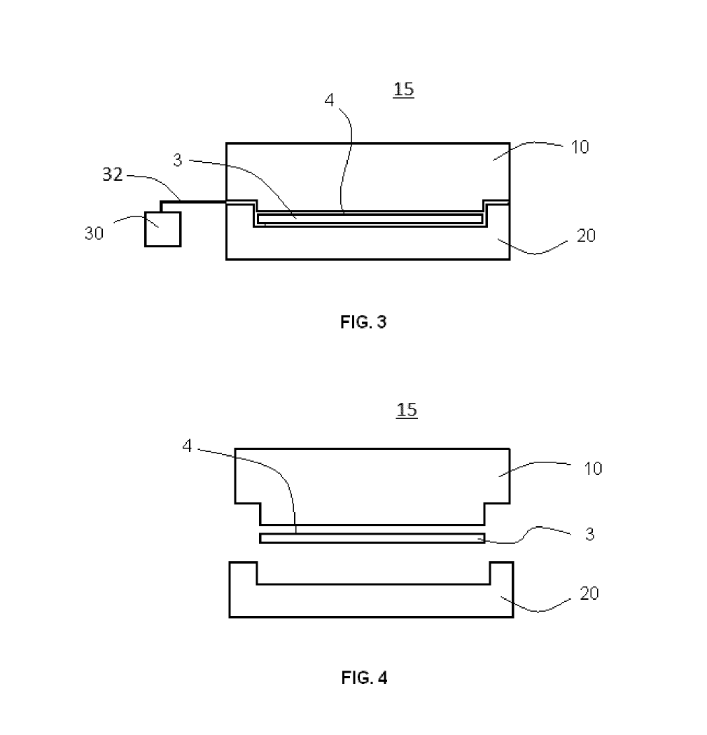

FIG. 2 is a schematic side view of the moulding tool 15 according to FIG. 1. Here, the first part 10 and the second part 20 of the moulding tool 15 are pressed together to essentially encompass the conductor bar 3. The pressure force is usually induced by a hydraulic device comprised by the moulding tool 15 to generate pressures in the range of 1 bar to 50 bar. In the view of FIG. 2 left from the moulding tool 15 a feeder 30 is arranged which is connected to the moulding tool 15 via a feed channel 32 to supply a thermoplastic material to the moulding tool 15. This feeder 30 will only be used in the second embodiment described above. The feed channel 32 is connected to the moulding tool 15 space between the first part 10 and the second part 20, whereas the space is formed with the first part 10 and the second part 20 pressed against each other. The feed channel 32 serves for inserting a thermoplastic material or a precursor material from the feeder 30 to the inside of the moulding tool 15 to impregnate the conductor bar 3. In the view of FIG. 2 right from the moulding tool 15 a vacuum pump 40 or vacuum generator is arranged which is connected to the moulding tool 15 via a flexible hose 42. Here, again the flexible hose 42 is connected to a space or channel formed between the first part 10 and the second part 20. The vacuum pump 40 generates a vacuum within the moulding tool 15 in the second manufacturing step. Furthermore, a heating device (not shown) is comprised by the moulding tool 15 to apply heat to the inside of the moulding tool 15 to the end of melting the thermoplastic material. This procedure of applying a vacuum and heat in the moulding tool 15 is similar to the concept of vacuum assisted resin transfer moulding (VRTM). In an embodiment, the moulding tool 15 is preheated and the vacuum pump 40 creates a vacuum in the area in which the conductor bar 3 is placed according to FIG. 2. Then, liquid material is injected from the feeder 30. In this step hydrostatic pressure smaller than the closing pressure of the moulding tool 15 is applied to the feeder 30 and the vacuum pump 40 is disconnected. In case the material is an oligomeric thermoplastic or a precursor material applied to the conductor bar 3 as described above, it will be polymerized inside the mould tool 15 caused by means of heating. Starting materials as caprolactam contain additionally activators and catalysts. Compared to commonly used epoxy materials or epoxy, caprolactam as well as cyclic butylene terephthalate exhibit a melt viscosity of 0.02-0.03 Pas at operation temperature. This is well below the upper threshold value for impregnation with standard epoxies which is around 0.3 Pas. Furthermore, according to the requirements of the application, softeners, tougheners, and antioxidants can be added to the supply feeder 30. The moulding tool 15 applies a pressure in the range of approximately 1 bar to 20 bar to the conductor bar 3. The polymerization, required in the second embodiment, is done in the third manufacturing step, shown by example in FIG. 3. In FIG. 3 the moulding tool 15 is still heated to heat up the conductor bar 3. The application of a vacuum by the vacuum pump 40 is not necessary in the third manufacturing step but it has some advantages over the manufacturing without applying a vacuum. The thermoplastic material is melted in the moulding tool 15, fills the gaps at the mica and also the gaps at the glass-mica if applied. The thermoplastic material forms an insulation 4 for the conductor bar 3, then referred to as insulated conductor bar 3. The excessive thermoplastic material is pressed out when in a low viscosity condition.

FIG. 4 is a schematic side view of a moulding tool 15 according to FIG. 3 in a fourth manufacturing step with the two parts 10, 20 removed from each other and the insulated conductor bar 3 to be removed from the moulding tool 15. Finally, the heated conductor bar 3 is cooled down and removed from the moulding tool 15. Thermoplastic polymers on the conductor bar 3 as described here do not need to be cured which usually needs hours of dwell time inside the moulding tool 15 in the state of the art. The conductor bar 3 according to this disclosure can be removed from the moulding tool 15 as soon as the temperature in the moulding tool 15 is below the melting temperature of the thermoplastic material. The process time of the insulated conductor bar is reduced.

In both embodiments, the polymers, oligomeres or other polymer-precursors may contain inorganic fillers, including micrometer or nanometer-sized partices of oxides and nitrides, such as Al2O3, SiO2, TiO2, BaTiO3, BN, Ti3N4. Such fillers help to improve the dielectric properties and/or thermal conductivity of the insulation.

While the embodiments have been described in detail with reference to exemplary aspects thereof, it will be apparent to one skilled in the art that various changes can be made, and equivalents employed, without departing from the scope of the application. The foregoing description of the preferred embodiments have been presented for purposes of illustration and description. It is not intended to be exhaustive or to limit the application to the precise form disclosed, and modifications and variations are possible in light of the above teachings or may be acquired from practice of the embodiments. The embodiments were chosen and described in order to explain the principles and aspects and their practical application to enable one skilled in the art to utilize the various embodiments as are suited to the particular use contemplated. It is intended that the scope of the application be defined by the claims appended hereto, and their equivalents. The entirety of each of the aforementioned documents is incorporated by reference herein. In practice the materials used and the dimensions can be chosen at will according to requirements and to the state of the art.

What is claimed is:

1. An insulated conductor bar for an electric machine, comprising:
an insulation comprised of a tape made from one of a mica material, a mica material on a glass fabric, or a mica material on a polyester film, wherein a thermoplastic material is applied to the one of the mica material, the mica material on the glass fabric, or the mica material on the polyester film.

2. The insulated conductor bar according to claim 1, wherein the thermoplastic material is dispersed or scattered on the mica material on the glass fabric, and the mica material on the glass fabric is fused with the thermoplastic material.

3. The insulated conductor bar according to claim 2, wherein a method of calendaring is used for fusing the mica material on the glass fabric and the thermoplastic material.

4. The insulated conductor bar according to claim 1, wherein the thermoplastic material is created from at least a precursor material, at least a monomer, or at least an oligomer, and the at least a precursor material, the at least a monomer, or the at least an oligomer is converted to the thermoplastic material in a moulding tool for moulding the insulated conductor bar.

5. The insulated conductor bar according to claim 4, wherein the thermoplastic material is the precursor of polyamide 6 (PA6), caprolactam, or a cyclic oligomer of the Polybutylen-terephthalat (PBT).

6. The insulated conductor bar according to claim 5, wherein the thermoplastic material is fully polymerized in its final form and/or semicrystalline.

7. The insulated conductor bar according to claim 1, wherein the thermoplastic material is integrated in the tape made of one of the mica material, the mica material on the glass fabric, or the mica material on the polyester film.

8. The insulated conductor bar according to claim 1, wherein the thermoplastic material comprises inorganic fillers and the inorganic fillers exhibit a grain size between 20 nm and 20 μm, and/or the inorganic fillers are oxides of nitrides.

9. The insulated conductor bar according to claim 1, wherein a thermoplastic carrier fabric replacing the glass fabric is melted thereby creating a feedstock for impregnation.

10. The insulated conductor bar according to claim 1, wherein a layer of mica tape and a layer of thermoplastic tape are wound around the conductor bar.

11. A conductor bar insulation fabricated from a tape made from one of a mica material, a mica material on a glass fabric, or a mica material on a polyester film, wherein a thermoplastic material is applied to the one of the mica material, the mica material on the glass fabric, or the mica material on the polyester film.

12. A thermoplastic material to be used for manufacturing an insulated conductor bar of an electric machine according to claim 1.

13. A method for impregnating an insulated conductor bar, comprising the steps of:
covering the conductor bar with a tape made from one of a mica material, a mica material on a glass fabric, or mica material on a polyester film;
covering the conductor bar with a thermoplastic material;
inserting the conductor bar into a moulding tool;
heating the moulding tool;
evacuating the moulding tool with a vacuum pump; and
applying pressure to the moulding tool.

14. The method for impregnating an insulated conductor bar according to claim 13, wherein covering the conductor bar with the tape made from one of the mica material, the mica material on the glass fabric, or the mica material on the polyester film is alternated with covering the conductor bar with tapes of a thermoplastic material.

15. The method for impregnating an insulated conductor bar according to claim 13, further comprising injecting a molten thermoplastic material into the moulding tool with a feeder.
